(19) United States
(12) Patent Application Publication
(10) Pub. No.: US 2024/0072507 A1
(43) Pub. Date: Feb. 29, 2024

(54) FIBER OPTIC AMPLIFIER

(71) Applicant: NIPPON TELEGRAPH AND TELEPHONE CORPORATION, Tokyo (CN)

(72) Inventors: Shinichi AOZASA, Musashino-shi, Tokyo (JP); Taiji SAKAMOTO, Musashino-shi, Tokyo (JP); Kazuhide NAKAJIMA, Musashino-shi, Tokyo (JP); Takashi MATSUI, Musashino-shi, Tokyo (JP)

(73) Assignee: NIPPON TELEGRAPH AND TELEPHONE CORPORATION, Tokyo (JP)

(21) Appl. No.: 18/269,611

(22) PCT Filed: Jan. 21, 2021
(86) PCT No.: PCT/JP2021/002094

§ 371 Date: Jun. 26, 2023

(51) Int. Cl. H01S 3/10; F21V 8/00

(52) U.S. Cl. CPC H01S 3/10023; G02B 6/0003

(57) ABSTRACT

The purpose of the present invention is to provide an optical fiber amplifier capable of seamlessly and collectively amplifying optical signals in a plurality of bands.

In order to achieve the aforementioned purpose, the optical fiber amplifier according to the present invention is the optical fiber amplifier that amplifies multiple wavelength bands, and in cross-section, one signal light primary propagation region, and a doped region where rare-earth ions have been added, wherein the doped region includes the rare-earth-doped optical fiber existing other than the propagation region. The optical fiber amplifier uses the fact that the main propagation regions of the signal light are made the same in the fiber cross-section of the rare-earth-doped optical fiber and the propagation regions of the signal light are partially different in the signal wavelength, and adds rare-earth ions to the partially different propagation regions to make amplification factors different for each signal wavelength and flatten the gain of each amplification wavelength band.

### TECHNICAL FIELD

The present disclosure relates to an optical fiber amplifier for collectively optically amplifying optical signals in a plurality of wavelength bands.

### BACKGROUND ART

FIG. 1 is a diagram for explaining an optical fiber amplifier provided with a rare-earth-doped optical fiber for collectively amplifying the C-band (1530-1565 nm) and the L-band (1565-1600 nm). An erbium-doped optical fiber is used for amplification of the C-band and L-band. The optical fiber amplifier of FIG. 1 demultiplexes the C-band and the L-band, amplifies them with separate amplifiers, and then multiplexes them again to collectively amplify the C-band and the L-band (for example, see NPL 1).

### CITATION LIST

### Non Patent Literature

[NPL1] Yan Sun, James W. Sulhoff, Atul K. Srivastava, John L. Zyskind, and Chuck Wolf, “Ultra Wide Band Erbium-Doped Silica Fi-ber Amplifier with 80 nm of Bandwidth”, OSA, Optical Amplifiers and Their Applications 1997, pp. 144-147, 1997.

### SUMMARY OF INVENTION

### Technical Problem

Since the optical fiber amplifier shown in FIG. 1 performs optical amplification by demultiplexing the respective bands, the loss of the multiplexing/demultiplexing device is high at the boundary region of the two bands (about several nanometers to ten-odd nanometers), and the number of the boundary region of the two bands and the sufficient amplification and low noise property are not obtained in the boundary region, and it is difficult to obtain the amplification wavelength band.

FIG. 3 is a diagram for explaining an optical fiber amplifier in which a C-band optical amplifier 14 and an L-band optical amplifier 15 are connected in series. Reference signs 11 and 16 denote isolators, reference sign 13 denotes an excitation light source, and reference sign 12 denotes an optical multiplexer. The optical fiber amplifier as shown in FIG. 3 receives a large loss when the signal in the C-band passes through the optical fiber amplifier 15 in the L-band.

The reason for this will be described with reference to FIG. 2. FIG. 2 is a diagram illustrating the gain spectrum in each population inversion state of erbium ions. The numerical values (0%, 30%, 35%, . . . ) shown in the graph of FIG. 2 represent population inversion state. The light-emitting region means a state in which an optical signal can be performed optical amplification, and the absorption region means a state in which a loss is given to the optical signal. For example, if the population inversion state is 30%, the optical signal of the L-band can be amplified, but it can be seen that loss is given to the optical signal in the C-band.

The value of the population inversion state in FIG. 2 represents a value averaged over the longitudinal direction of the erbium-doped optical fiber. Therefore, even if the value of the population inversion state in FIG. 2 is 50%, the value of the population inversion state may be 70% at the input terminal and the value of the population inversion state may be 30% at the output terminal. Therefore, in FIG. 2, when the value of the population inversion state is 50%, the optical signal of the C-band is in the light-emitting region, but the value of the population inversion state is not 50%, depending on the position in the longitudinal direction of the erbium-doped optical fiber, and C-band optical signals may suffer loss.

When an L-band signal is amplified by the L-band amplifier 15, the value of population inversion state where the gain becomes flat over the entire L-band as shown in FIG. 2 is about 30%-50%. If the value of the population inversion state is less than 30%, the amplification will not be effective, and if it is more than 50%, the gain in the C-band will be too large, causing oscillation or other instability in the amplifier and significantly degrading the excitation efficiency. Therefore, it is necessary to keep the population inversion state of erbium ions in an erbium-doped optical fiber (EDF) low (about 30% to 50%). However, under the above conditions, there is a possibility that the C-band becomes an absorption region for erbium ions, and in this case, the signal in the C-band is subjected to a large loss.

Therefore, due to the basic physical properties of the rare-earth ions to be added, it was difficult to collectively amplify the C-band and L-band even with optical fiber amplifiers configured with amplifiers connected in series as shown in FIG. 3. Both the optical fiber amplifiers shown in FIGS. 1 and 3 are amplified using rare-earth-doped optical fibers having the same doped region of rare-earth ions as shown in FIG. 4.

Accordingly, it is an object of the present invention to provide an optical fiber amplifier capable of seamlessly collectively amplifying optical signals in a plurality of bands in order to solve the above problems.

### Solution to Problem

In order to achieve the above-mentioned object, the optical fiber amplifier according to the present invention adjusts the doped region of rare-earth ions of the rare-earth-doped optical fiber according to the band of the optical signal to be amplified.

Specifically, the optical fiber amplifier according to the present invention is an optical fiber amplifier that amplifies a plurality of wavelength bands, the optical fiber amplifier includes a rare-earth-doped optical fiber, wherein a cross-section of the rare-earth-doped optical fiber includes a main propagation region for signal light, and a doped region doped with rare-earth ions, and the doped region exists other than the propagation region.

The optical fiber amplifier uses the fact that the main propagation regions of the signal light are made the same in the fiber cross-section of the rare-earth-doped optical fiber and the propagation regions of the signal light are partially different in the signal wavelength, and adds rare-earth ions to the partially different propagation regions to make amplification factors different for each signal wavelength and flatten the gain of each amplification wavelength band.

Here, since some signal light exists in a non-negligible proportion in any of the regions across multiple propagation regions depending on the signal wavelength, the difference in the existence rate in the multiple propagation regions involving the signal light is also considered to be “partially different propagation regions”. This interpretation also includes that two EDFs are connected in series, and that the front stage and rear stage have different propagation regions (rare-earth ions doped regions) where the main gain can be obtained depending on the signal wavelength.

When the invention is applied to the series-type optical fiber amplifier shown in FIG. 3, rare-earth ions are added in the EDF of the L-band amplifier in the rear stage in a region other than the propagation region of the C-band signal light, and the propagation region of almost only L-band signal light. Here, the region other than the propagation region of the C-band signal light includes regions where the presence of C-band signal light is minute (a few percent or less). By using such an EDF, an increase in the loss of the C-band signal in the L-band amplifier can be avoided, and the C-band and L-band amplification can be performed collectively. Furthermore, since the optical fiber amplifier is a series type optical fiber amplifier, a multiplexing/demultiplexing device which has been a cause of optical amplification of a boundary region between the C-band and the L-band due to multiplexing of an amplification wavelength band is not used, so that the C-band and the L-band having seamless and flat gain can be collectively amplified. Further, the wavelength band to be amplified can be controlled by adjusting the doped region of the rare-earth ions in the EDF.

Therefore, the present invention can provide an optical fiber amplifier capable of seamlessly and collectively amplifying optical signals of a plurality of bands.

It should be noted that “the main propagation region of the signal light in the cross-section of the amplifying optical fiber” and “the main propagation region of the signal light in the cross-section” means that the main existing region of the electric field distribution coincides regardless of the signal wavelength. The case where the center positions of the electric field distributions are almost coincident or the case where the electric field distributions are largely overlapped even if the center positions are deviated is included.

As a conventional technique, there is a method of realizing different propagation regions of signal light by setting different amplification wavelength bands for each core in a non-coupled multi-core fiber, but this is clearly different from the above claims of the invention because the main propagation region of the signal light is not one but the non-coupled propagation region completely separated for each amplification wavelength band is used.

As described above, the optical fiber amplifier according to the present invention is a series-type, wherein the rare-earth-doped optical fiber is divided into a plurality of sections, and an arrangement of the doped region is different for each of the sections.

On the other hand, the rare-earth-doped optical fiber of the optical fiber amplifier according to the present invention may have the same arrangement of the doped regions over the entire section, and the propagation region may be also doped with rare-earth ions.

The rare-earth-doped optical fiber of the optical fiber amplifier according to the present invention may have a doping concentration of the rare-earth ions in at least one of the doped regions different from a doping concentration of the rare-earth ions in the other of the doped regions.

The optical fiber amplifier according to the present invention seamlessly and collectively amplifies optical signals in a plurality of bands by utilizing the fact that a population inversion state is formed for each of the doped regions and the population inversion state used for each of the wavelength bands is different.

Next, the means of forming partially different propagation regions of signal light (an example where signal light propagates outside of one main propagation region of signal light) will be described. The first means (FIGS. 5 and 7), which is realized by lightwave coupling by setting a region with a higher refractive index than the cladding (side core) outside the central core, and the second means (FIGS. 6 and 8), which uses the difference in the spread of the electric field distribution associated with the wavelength dependence of the signal light. FIGS. 5 to 8 illustrate the cross-sectional structure of rare-earth-doped optical fiber (refractive index distribution and rare-earth ions doped region).

As shown in FIG. 5, the rare-earth-doped optical fiber of the optical fiber amplifier according to the present invention, within a cross-section of an optical fiber, may have a central core in said propagation region and a core region concentrically arranged with respect to the central core, and in at least one of the sections, the core region may be the doped region.

FIG. 5 shows a case where a high refractive index region is provided in the cladding portion and rare-earth ions (erbium ions in this case) are added to the cladding portion. The high refractive region in the cladding portion mainly pulls the electric field of the L-band to the outside of the fiber cross-section, and the erbium ions added to the region allow optical amplification around the L-band. Since the electric field of the C-band does not substantially exist in this region, light loss due to absorption does not substantially occur even if the population inversion state is low. Therefore, the rare-earth-doped optical fiber having the structure shown in FIG. 5 can amplify the L-band signal while simultaneously transmitting the C-band and L-band signals while causing almost no loss to the C-band signal. By installing a C-band optical fiber amplifier having a general rare-earth-doped optical fiber in a high population inversion state as shown in FIG. 4 in the front stage, an optical fiber amplifier capable of performing seamless batch amplification of C-band and L-band can be provided.

As shown in FIG. 6, the rare-earth-doped optical fiber of the optical fiber amplifier according to the present invention may have a central core in the propagation region within a cross-section of an optical fiber, and in at least one of the sections, the doped region may be concentrically arranged with respect to the central core.

FIG. 6 shows the case where the cladding portion has no high refractive index region and rare-earth ions are added thereto. Due to the difference in the spread of the electric field due to the difference in the signal wavelength, the electric field of the L-band spreads to the outside of the cladding portion. The erbium ions added to the region of the cladding portion enable optical amplification around the L-band. In this region, since the electric field intensity of the C-band is smaller than that of the L-band, the signal of the L-band is preferentially amplified. Therefore, the rare-earth-doped optical fiber having the structure shown in FIG. 6 can amplify the L-band signal while simultaneously transmitting the C-band signal and the L-band signal without substantially giving loss to the C-band signal. By installing a C-band optical fiber amplifier having a general rare-earth-doped optical fiber in a high population inversion state as shown in FIG. 4 in the front stage, an optical fiber amplifier capable of performing seamless batch amplification of C-band and L-band can be provided.

In the structure shown in FIG. 6, compared to the structure shown in FIG. 5, it is difficult to sufficiently lower the electric field strength in the C-band than the electric field strength in the L-band in the doped region of the cladding portion, and the signal light in the C-band is susceptible to the influence of absorption by erbium ions. Therefore, the structure shown in FIG. 5 can improve the wide band and low noise property as compared with the structure shown in FIG. 6. As shown in FIG. 7, the rare-earth-doped optical fiber of the optical fiber amplifier according to the present invention, within a cross-section of an optical fiber, may have a central core in the propagation region and a core region concentrically arranged with respect to the central core, and the doped region may have the central core and the core region. It is preferable that the doped region located at the position of the central core and the doped region arranged concentrically with respect to the central core have different doping concentrations of the rare-earth ions.

FIG. 7 shows a structure in which erbium ions are also added to the central core, as compared with the structure shown in FIG. 5. The amplification of the C-band can be performed simultaneously with the L-band by one optical fiber for amplification. However, since the amplification factor per unit ion differs between the C-band and the L-band as shown in FIG. 2, it is necessary to appropriately adjust the erbium ion doping concentration of the central core and the erbium ion doping concentration of the cladding portion. Since the amplification factor per unit ion in the L-band is low, it is desirable to set the erbium-doped concentration in the cladding portion to be high.

As shown in FIG. 8, the rare-earth-doped optical fiber of the optical fiber amplifier according to the present invention may have a central core that is the propagation region, within a cross-section of the optical fiber, and the doped region may be arranged at a position of the central core and arranged concentrically with respect to the central core. It is preferable that the doped region located at the position of the central core and the doped region arranged concentrically with respect to the central core have different doping concentrations of the rare-earth ions.

FIG. 8 shows a structure in which erbium ions are also added to the central core, as compared with the structure shown in FIG. 6. The amplification of the C-band can be performed simultaneously with the L-band by one optical fiber for amplification. However, since the amplification factor per unit ion differs between the C-band and the L-band as shown in FIG. 2, it is necessary to appropriately adjust the erbium ion doping concentration of the central core and the erbium ion doping concentration of the cladding portion. Since the amplification factor per unit ion in the L-band is low, it is desirable to set the erbium-doped concentration in the cladding portion to be high.

FIG. 9 plots the wavelength dependence of the light intensity in the central core portion versus the light intensity in the high refractive index region (ring shape) of the cladding portion (without erbium ion addition and without amplification) for a segment type optical fiber, which is an example of FIG. 5. The light on the long wavelength side is coupled to the clad side by the light wave coupling, and the light intensity on the clad side becomes higher at 1600 nm or more. Therefore, by adding erbium ions to the cladding portion, the optical amplification of the L-band signal can be performed efficiently.

On the other hand, FIG. 10 shows the wavelength dependence of the light intensity of the central core portion, and the light intensity of the cladding portion (without erbium ion addition and without amplification) for a normal optical fiber with only a central core, which is a plotted figure of an example of FIG. 6. As the wavelength becomes longer, the light intensity of the cladding portion increases. Therefore, by adding erbium ions to the cladding, L-band amplification is possible.

However, in the case of the ordinary optical fiber structure, compared with the segment type optical fiber (FIG. 9) the wavelength dependency of the light intensity is small, and the addition of erbium ions to the cladding portion can obtain a small amount of optical amplification of the L-band signal.

The difference in light intensity between the C-band and the L-band in the cladding portion described with reference to FIGS. 9 and 10 affects the amplification efficiency in the cladding portion. In other words, when considering the entire amplifier including the C-band and the L-band, the structure of the optical fiber affects the ratio of gains obtained in the C-band and the L-band, and therefore affects the length and the amplification bandwidth of the erbium-doped optical fiber necessary for gain equalization.

FIG. 11 is a diagram illustrating the relationship between the amplification bandwidth and the length of the erbium-doped optical fiber (EDF length) for each optical fiber structure. The {1} multi-core optical fiber and the {2} segment optical fiber are structures (corresponding to FIG. 5) that utilize optical wave coupling. {3} single-core optical fiber has a structure (corresponding to FIG. 6) that utilizes the difference in the spread of the electric field depending on the wavelength. In the optical fiber amplifier which has been studied, a single core type erbium-doped optical fiber in which erbium ions are added to the central core is connected to the front stage side, and an EDF of structure {1}, {2} or {3} is connected to the rear stage side. In this optical fiber amplifier, the relationship between the length of the EDF on the rear stage side and the amplification bandwidth is plotted.

An amplification bandwidth of 30 nm on the left end of the horizontal axis in FIG. 11 indicates a C-band amplification band (1535 to 1565 nm) with a gain of 20 dB or more (amplification bandwidth by the front stage EDF). The term “amplification bandwidth” in the horizontal axis in FIG. 11 represents the entire amplification band obtained finally by connecting the optical fiber for amplification of the present invention to the rear stage and enlarging the amplification band from the amplification band of the C-band to the L-band side. As can be seen from FIG. 11, in the case of the {3} single core type, the EDF length is 100 m, and the band can be expanded by about several nm. On the other hand, in the {2} segment type optical fiber, the amplification band is expanded to 55 nm with the same EDF length of 100 m, and it can be seen that light wave coupling is more effective for band expansion. In this figure, the {2} segment type is superior to the {1} multi-core type, but it can be designed to the same level depending on the design conditions.

Next, taking a segment type fiber that utilizes optical wave coupling as an example, the design conditions regarding the wavelength characteristics of the signal light intensity of the core and cladding portion will be shown as necessary conditions for fiber design to achieve a desired amplification band. This example is a series-type optical fiber amplifier in which a single-core erbium-doped optical fiber with erbium ions doped only to the cladding portion on the rear stage side and a single-core erbium-doped optical fiber with erbium ions added to the central core on the front stage side are connected. The study here can also be applied to the case where both the core and the cladding portion are doped with erbium ions and one EDF is used as an optical fiber amplifier.

The amount of coupling from the core mode to the ring mode of the optical fiber of the present invention is schematically represented as shown in FIG. 12. Let λc be the conversion center wavelength (the center wavelength of the coexisting wavelength range of the supermodel and fundamental mode) and λw be the conversion bandwidth (the coexisting wavelength range of the supermodel and fundamental mode). λc and λw are parameters necessary for designing the amplification optical fiber, and must be derived together with the amplification characteristics. The derivation process and the conditions thereof will be described below.

FIG. 13 is a diagram explaining an example of a gain spectrum of an optical fiber amplifier. In FIG. 13, the curve a is the gain spectrum of the front stage amplification optical fiber, the curves 131 to 133 are the gain spectra of the rear stage amplification optical fiber, and the curves γ1 to γ3 are the total gain spectrum.

The population inversion state of the amplifying optical fiber on the front stage side is 70%.

Curves β1, β2, and β3 are gain spectra when the population inversion state of the amplification optical fiber on the rear stage side is 40%, 50%, and 60%.

Curves γ1, γ2, and γ3 are overall gain spectra when the population inversion state of the amplifying optical fiber on the rear stage side is 40%, 50%, and 60%.

By optimizing the population inversion states and λc and λw of the optical fibers for amplification on the front stage side and the rear stage side, a flat gain spectrum like a curve γ2 can be obtained. In FIG. 13, the population inversion state of the C-band of the amplifying optical fiber on the front stage side is fixed to 70%, and the population inversion state of the L-band of the amplifying optical fiber on the rear stage side is changed to derive the population inversion state in which the gain deviation is minimized. As a result, in this example, the population inversion state of the L-band in which the gain deviation is the smallest was 50%. Although the EDF length must also be optimized, the EDF length at which the total gain spectrum becomes the smallest is uniquely determined.

FIG. 14 is a diagram for explaining a gain deviation in the relationship between the C-band population inversion state of the amplifying optical fiber on the front stage side and the L-band population inversion state of the amplifying optical fiber on the rear stage side. In this figure, λc=1620 nm, and the flat gain amplification band to be set is 1540 to 1600 nm. When the average gain is 20 dB, the gain deviation 10% means 2 dB. A region with a gain deviation of 10% or less is a portion surrounded by a white dashed line.

FIG. 15 is a diagram plotting the conversion bandwidth λw under similar conditions. If the white dashed line in FIG. 14 is applied to FIG. 15 (indicated by the black solid line), the conversion bandwidth λw ranges from 115 to 125 nm. That is, the range of the black solid line indicates a conversion bandwidth λw in which gain deviation of 2 dB or less is obtained.

For FIG. 14 and FIG. 15, the range of conversion bandwidth λw derived in the same calculation process while changing λc was calculated. FIG. 16 is a diagram for explaining the results. There is a linear relationship between λc and λw, and fiber parameters must be determined so that they fall within this range. This condition is an example, and the condition may change depending on the difference in the type of optical fiber for amplification (set amplification band and additives). However, regardless of the differences in structural parameters (use of lightwave coupling, use of the difference in the spread of the electric field due to wavelength, and other means), the conditions for deriving the set amplification bandwidth, center wavelength, and conversion bandwidth will be similar.

A common single mode optical fiber (SMF) may be used in optical components and transmission lines, and versatility will be enhanced if it can be easily connected to the amplification optical fiber of the present invention. FIG. 17 is a diagram plotting the λc dependence of the connection loss (connection with end faces facing each other) between the amplification optical fiber shown in FIG. 5 and a normal SMF. As can be seen from the figure, the connection loss is 2 dB or less at 1600 nm or more.

FIG. 18 is a diagram plotting the EDF length dependence of λc under the condition that the gain deviation is the smallest for each λc. It can be seen that there is a linear relationship. Considering the manufacturing cost, 200 m or less is realistic, but λc in that case is 1650 nm. The results shown this time are an example of the results of connection by simply butting the end surfaces with a general SMF, and the connection loss can be greatly reduced by a spatial connection device, taper fusion, or the like.

Next, the type of the configuration of the optical fiber amplifier according to the present invention will be described. FIG. 19 is a diagram illustrating the configuration of an optical fiber amplifier according to the present invention. There are three structures of the amplifying medium 20 of the optical fiber amplifier according to the present invention.

### [Configuration A]

Front stage: EDF 24 in which erbium ions are added to the core portion in a normal single core (mainly C-band amplification)

Rear stage: EDF 25 of the present invention in which erbium ions are added only to the cladding portion (mainly L-band amplification)

### [Configuration B]

Front stage: EDF 25 of the present invention with erbium ions added only to the cladding portion (mainly for L-band amplification)

Rear stage: EDF 24 with the addition of erbium ions in the core portion of a normal single core (mainly C-band amplification)

### [Configuration C]

EDF 27 of the present invention in which erbium ions are added to both the core and the cladding portion (simultaneous amplification of C-band and L-band)

There are three arrangements in which the amplifying medium 20 as shown in FIG. 19 is incorporated into an optical fiber amplifier. FIG. 20 is a diagram illustrating a configuration incorporating an amplification medium. The configuration X is forward excitation, the configuration Y is backward excitation, and the configuration Z is bidirectional excitation. Each of the configurations shown in FIG. 19 and each of the configurations shown in FIG. 20 can be arbitrarily combined. Both core and cladding excitation can be combined, and in the case of core excitation, excitation light is less likely to be supplied to erbium ions added in the cladding portion. The optical fiber amplifier according to the present invention has a function of converting to a cladding mode by forming a grating in a core portion, thereby supplying excitation light to erbium ions added to the cladding portion.

Although a single core type, a multi-core type, and a segment type are exemplified, as the structure of an optical fiber in the present specification, a hole-assisted optical fiber, similar effects can be obtained even in optical fibers having different structures such as a hole-assisted optical fiber, photonic crystal optical fibers, photonic-band gap optical fibers, W-type optical fibers, double clad optical fibers, and the like.

Also, with respect to the mode multiplex optical fiber, the mode dependent gain can be controlled by setting the doped region of rare-earth ions according to different mode electric field distributions.

The rare-earth-doped optical fiber may have a plurality of sets of the propagation region and the doped region within a cross-section of the optical fiber. Thereupon, the sets are preferably non-correlated with each other in amplification of the wavelength band.

A multi-transmission path optical fiber is formed by bundling a plurality of sets of amplification medium structures (the aforementioned set) in which a main propagation region of signal light is one in a cross-section of the amplification optical fiber, at least two or more kinds of cross-section regions to which rare-earth ions are added exist in a propagation direction of the amplification optical fiber, and an doped region of the rare-earth ions is controlled according to an amplification wavelength band. At this time, the individual amplifying medium structures do not interact with each other and operate independently in a non-correlated manner. However, it is possible to collectively amplify a plurality of amplifying medium structures by cladding excitation or the like.

The above inventions can be combined wherever possible.

### Advantageous Effects of Invention

The present invention can provide an optical fiber amplifier capable of seamlessly and collectively amplifying optical signals in a plurality of bands.

### BRIEF DESCRIPTION OF DRAWINGS

FIG. 1 is a diagram for explaining a structure of an optical fiber amplifier.

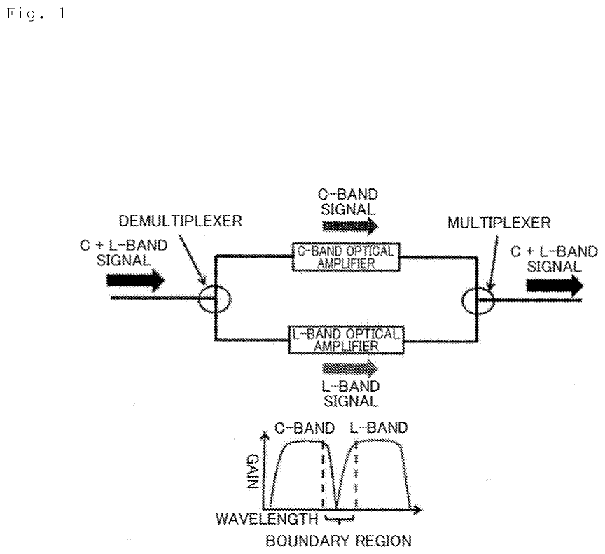

FIG. 2 is a diagram illustrating a gain spectrum in each population inversion state of erbium ions. Each curve is a gain spectrum with values of 0%, 10%, 20%, 30%, 35%, 40%, 50%, 60%, 70%, 80%, 90%, and 100% of the population inversion state from the bottom. In the C-band, the gain becomes flat when the value of the population inversion state is 60% or more, and in the L-band, the value of the population inversion state is 30% or more and 50 or less, and the gain becomes flat when the value of the population inversion state is 30% or more and 50% or less.

FIG. 3 is a diagram for explaining a structure of an optical fiber amplifier.

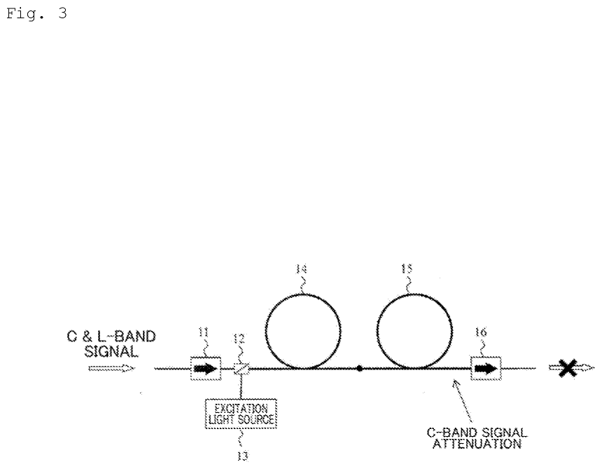

FIG. 4 is a diagram illustrating spread of an electric field distribution in a cross-section of an optical fiber.

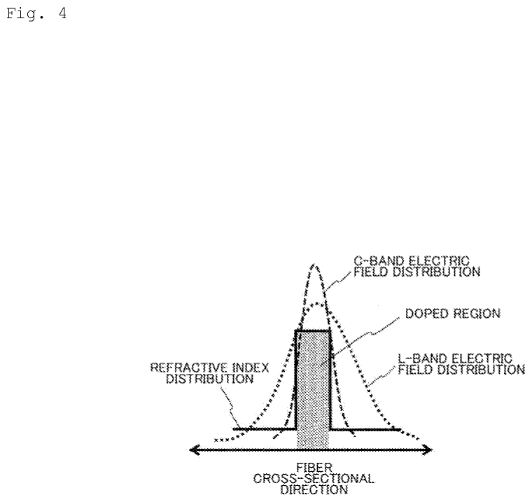

FIG. 5 is a diagram for describing a rare-earth-doped optical fiber provided by an optical fiber amplifier according to the present invention.

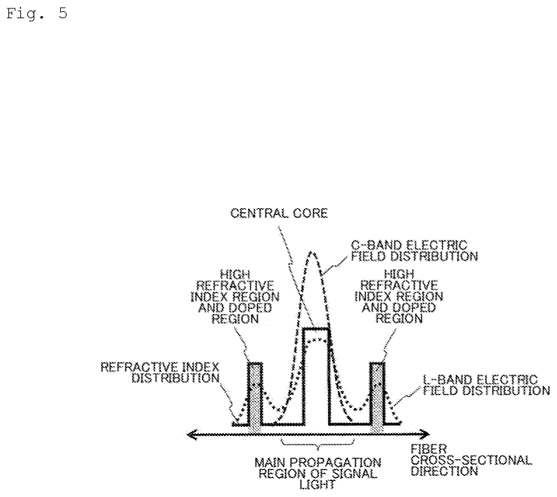

FIG. 6 is a diagram for describing a rare-earth-doped optical fiber provided by the optical fiber amplifier according to the present invention.

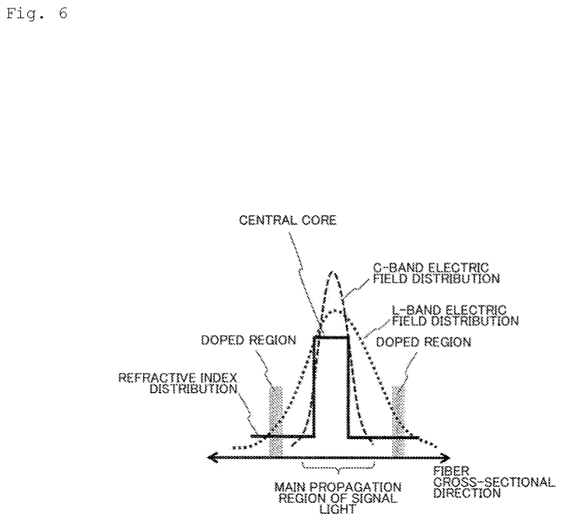

FIG. 7 is a diagram for describing a rare-earth-doped optical fiber provided by the optical fiber amplifier according to the present invention.

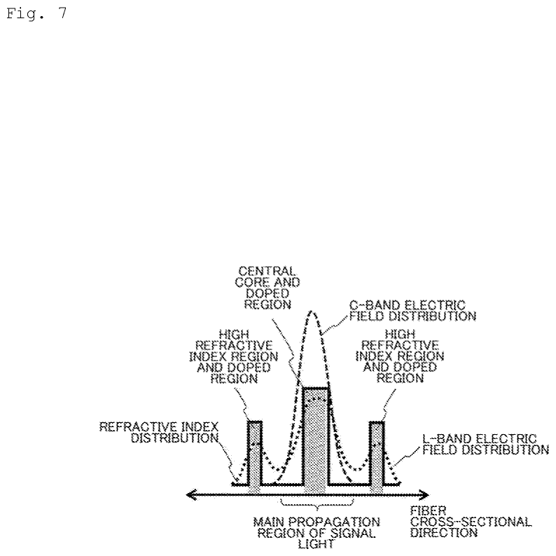

FIG. 8 is a diagram for describing a rare-earth-doped optical fiber provided by the optical fiber amplifier according to the present invention.

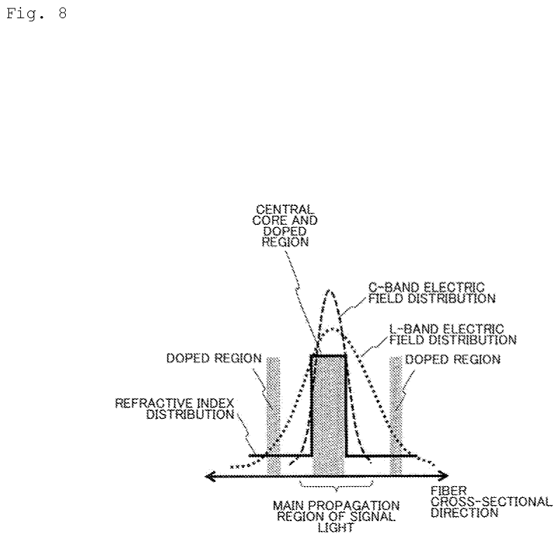

FIG. 9 is a diagram illustrating wavelength dependence of the light intensity of the central core portion and the light intensity of the cladding portion for a segment type optical fiber optical fiber.

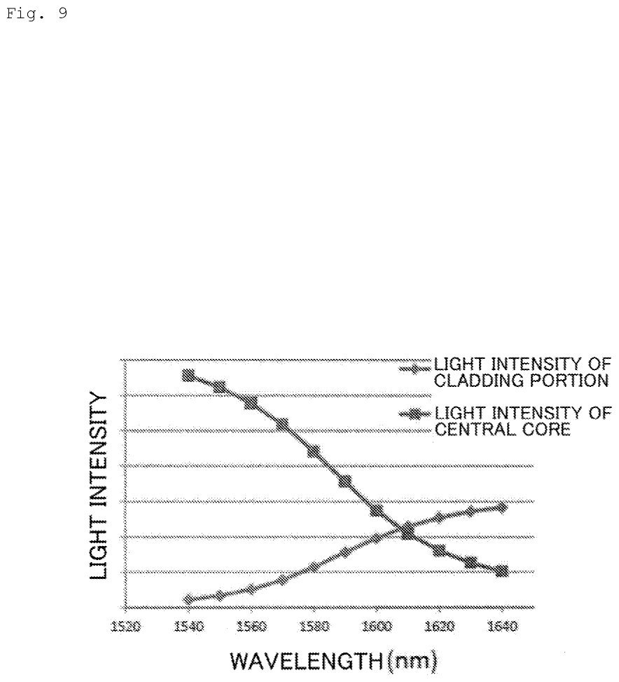

FIG. 10 is a diagram illustrating wavelength dependence of the light intensity of the central core portion and the light intensity of the cladding portion for a single core optical fiber.

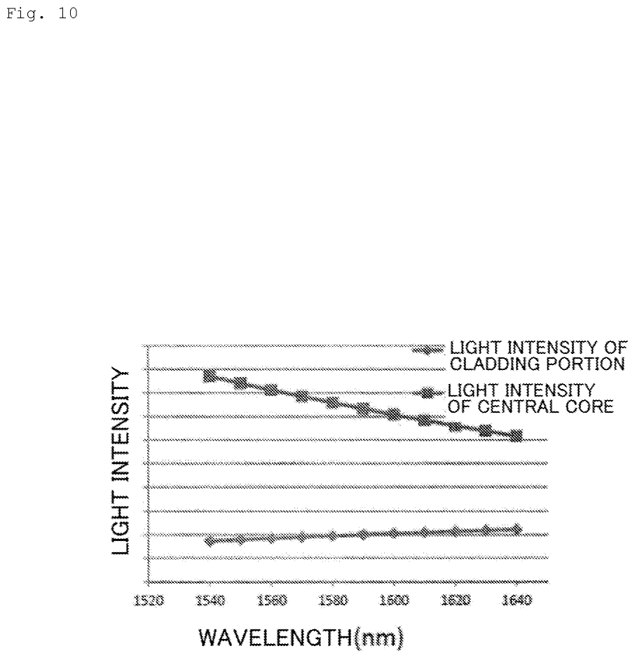

FIG. 11 is a diagram illustrating the relationship between amplified bandwidth and EDF length for each optical fiber structure.

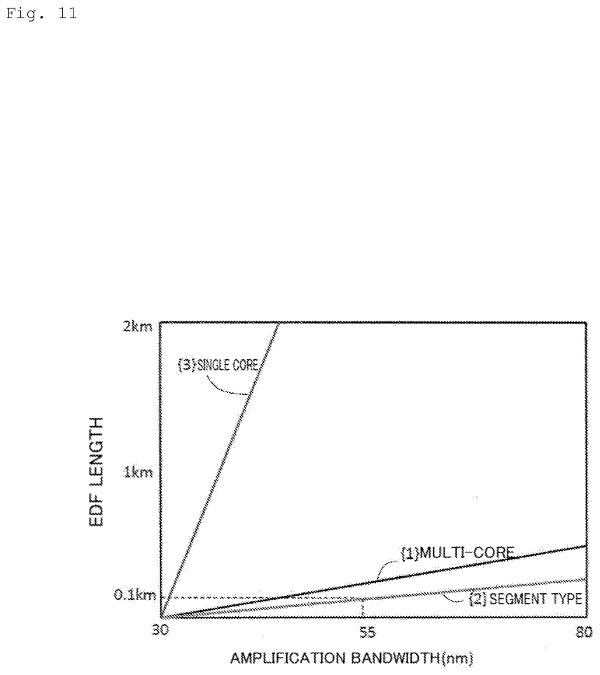

FIG. 12 is a diagram illustrating the amount of coupling from the core mode to the ring mode of the rare-earth-doped optical fiber provided in the optical fiber amplifier according to the present invention.

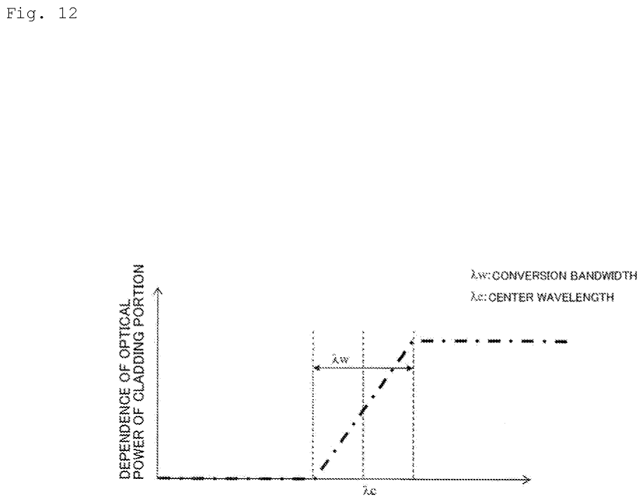

FIG. 13 is a diagram for describing an example of the gain spectrum of the optical fiber amplifier.

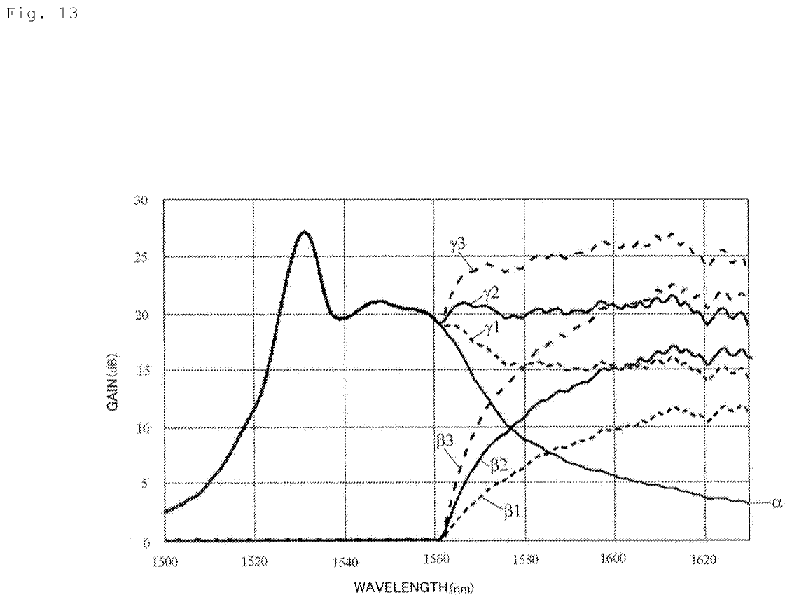

FIG. 14 is a diagram illustrating gain deviations in each population inversion state for rare-earth-doped optical fibers included in the optical fiber amplifier according to the present invention.

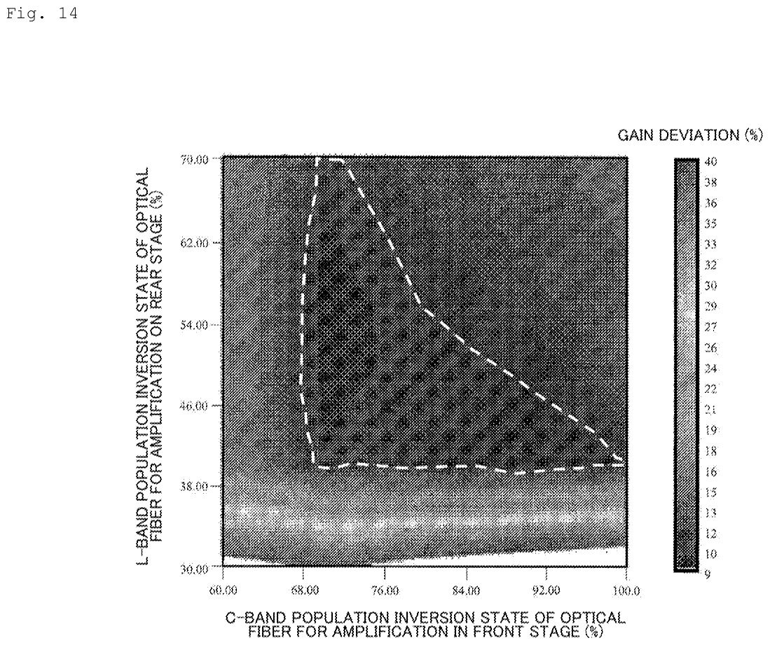

FIG. 15 is a diagram illustrating a conversion bandwidth in each population inversion state for rare-earth-doped optical fibers included in an optical fiber amplifier according to the present invention.

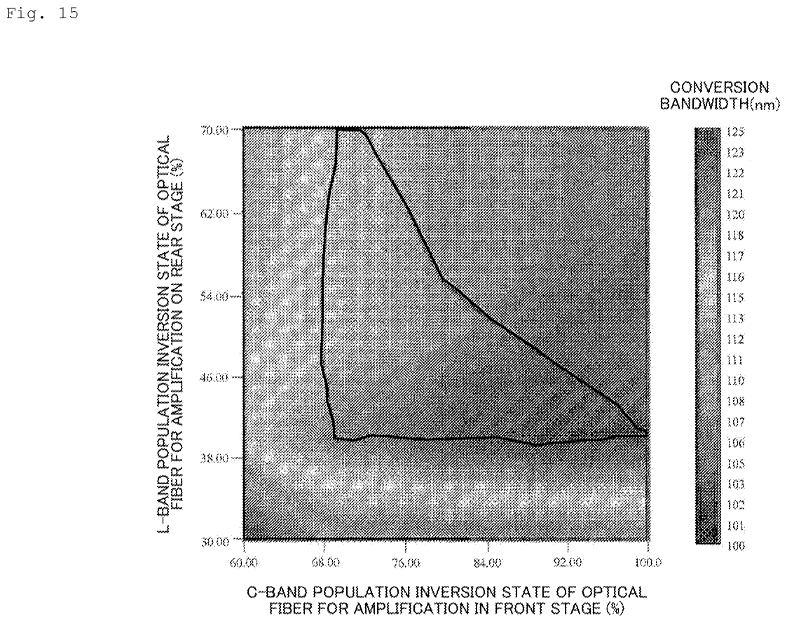

FIG. 16 is a diagram for describing dependence of the conversion bandwidth on a center wavelength in an optical fiber amplifier of the present invention.

FIG. 17 is a diagram illustrating the center wavelength dependence of the connection loss between the rare-earth-doped optical fiber and the SMF provided in the optical fiber amplifier according to the present invention.

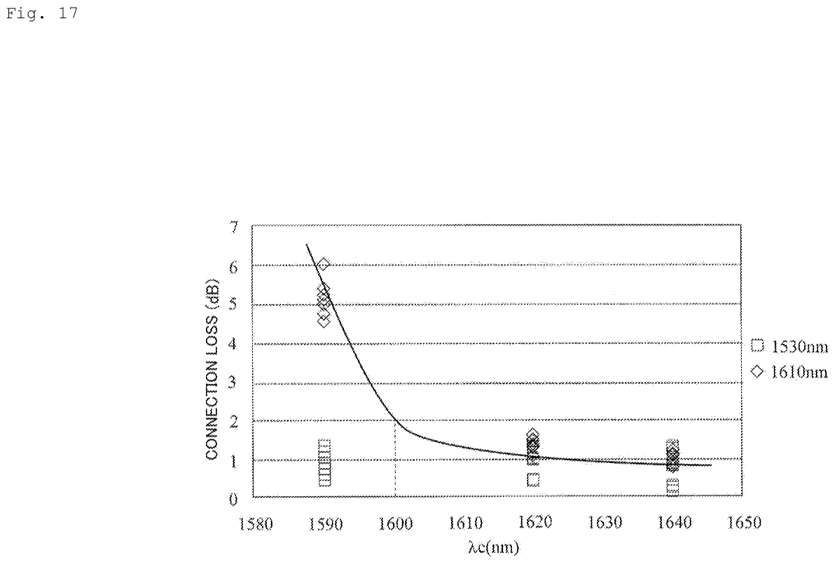

FIG. 18 is a diagram illustrating the center wavelength dependence of the length of the rare-earth-doped optical fiber included in the optical fiber amplifier according to the present invention.

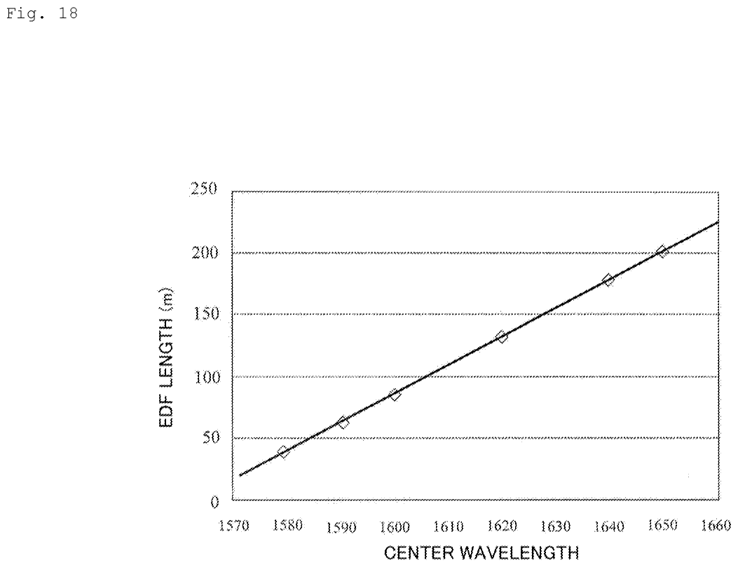

FIG. 19 is a diagram for describing a structure of an amplifying medium provided by an optical fiber amplifier.

FIG. 20 is a diagram for describing a structure of an optical fiber amplifier according to the present invention.

FIG. 21 is a diagram for describing an optical fiber amplifier according to the present invention.

FIG. 22 is a diagram for explaining structural parameters of a rare-earth-doped optical fiber included in an optical fiber amplifier according to the present invention.

FIG. 23 is a diagram for explaining structural parameters of a rare-earth-doped optical fiber included in an optical fiber amplifier according to the present invention.

FIG. 24 is a diagram for explaining structural parameters of a rare-earth-doped optical fiber included in an optical fiber amplifier according to the present invention.

FIG. 25 is a diagram for describing an optical fiber amplifier according to the present invention.

FIG. 26 is a diagram for describing an optical fiber amplifier according to the present invention.

FIG. 27 is a diagram for describing an optical fiber amplifier according to the present invention.

FIG. 28 is a diagram for describing an optical fiber amplifier according to the present invention.

### DESCRIPTION OF EMBODIMENTS

Embodiments of the present invention will be described with reference to accompanying drawings. The embodiments described below are examples of the present invention, and the present invention is not limited to the following embodiments. In the present specification and the drawings, the components having the same reference signs indicate the same components. Further, in this specification, if there is no special note on the population inversion state, it is assumed to represent the population inversion state averaged in the fiber longitudinal direction.

### Embodiment 1

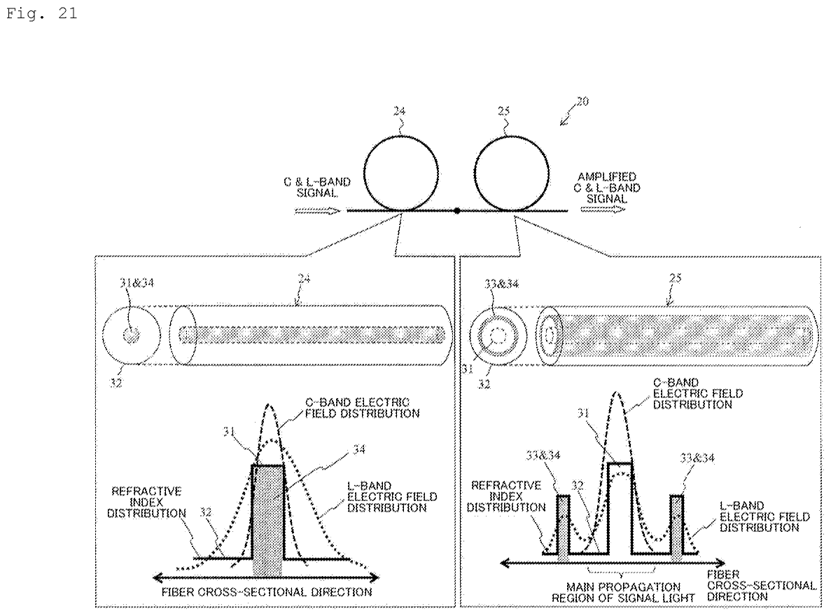

FIG. 21 is a view for explaining the rare-earth-doped optical fiber 20 included in the optical fiber amplifier of the present embodiment. In the rare earth-doped optical fiber 20 of this form, a step-type optical fiber 24 with erbium ions added to the center core on the front stage side, a segment-type refractive index distribution shape on the rear stage side, and a ring portion of Erbium ion-doped optical fiber 25 is connected in series. In each optical fiber, reference sign 31 denotes a central core, reference sign 32 denotes a cladding portion, reference sign 33 denotes a core region having a high refractive index (in this embodiment, it is ring-shaped), and reference sign 34 denotes a doped region to which erbium ions are doped.

The doped region 34 of the optical fiber 24 substantially coincides with the central core 31. Although the doped region 34 and the core region 33 of the optical fiber 25 are substantially coincident with each other, they are not necessarily coincident with each other.

The L-band signal light propagated through the central core 31 by the optical fiber 24 is partially mode-coupled to the ring-shaped core region 33 by the optical fiber 25 (super mode excitation). Therefore, the optical fiber 25 increases the existence ratio of the L-band electric field distribution of the cladding portion 32 while maintaining the absorption of the C-band erbium ions low, and realizes the L-band amplification with high efficiency and a wide band. As a result, the rare-earth-doped optical fiber 20 can be amplified around the C-band at the front stage and amplified around the L-band at the rear stage, so that seamless batch amplification from the C-band to the L-band can be performed as a whole.

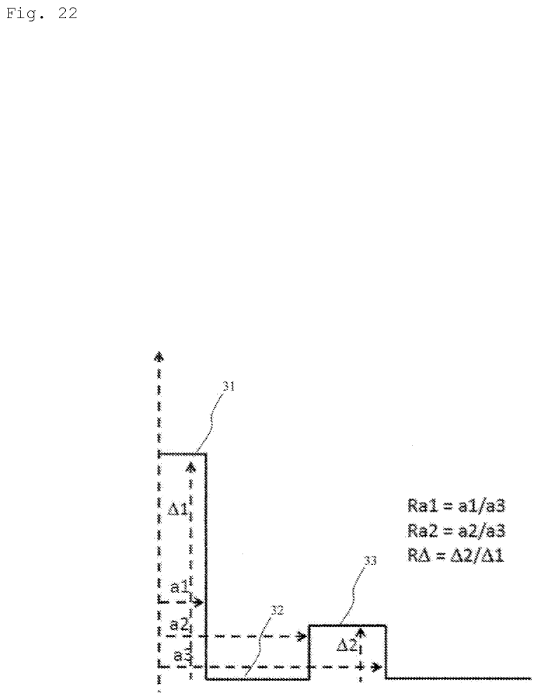

In order to clarify more detailed design conditions, the structural parameters of the optical fiber 25 are defined as shown in FIG. 22.
a1: radius of central core 31,
a2: inner radius of ring-shaped core region 33,
a3: outer radius of ring-shaped core region 33,
Δ1: relative refractive index difference of central core,
Δ2: relative refractive index difference of ring core,
Ra1=a1/a3, Ra2=a2/a3, and RΔ=Δ2/Δ1.

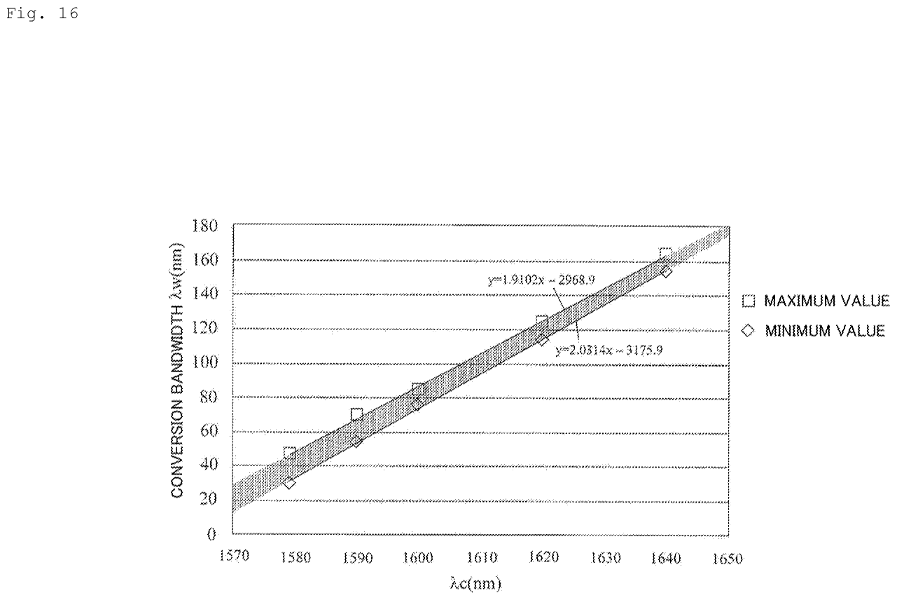

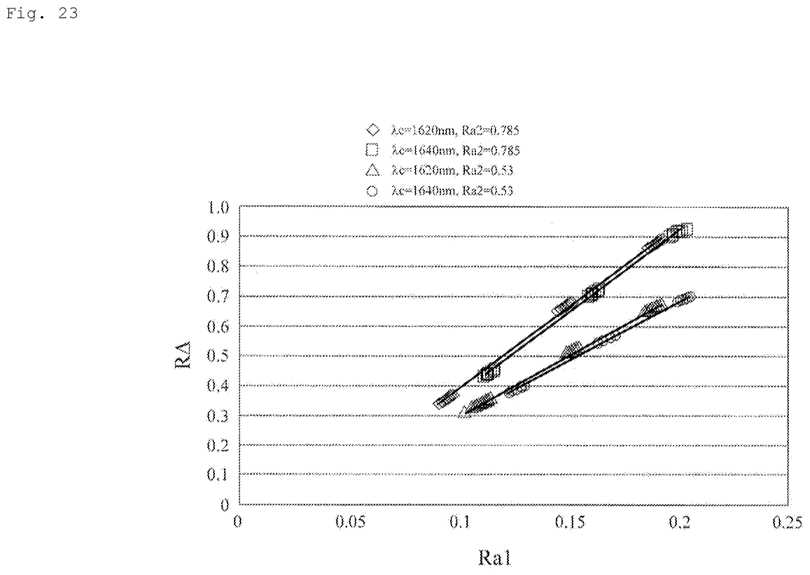

As a result of deriving structural conditions that satisfy the conditions of FIG. 16, it was confirmed that there is a linear relationship between Ra1 and RΔ as shown in FIG. 23. Furthermore, it is possible to incorporate Ra2, and the relationship of RΔ∝(b+c×Ra2)×Ra1 {b, c are coefficients} (in this example, the following formula) is confirmed, and the structural parameters satisfying the conditions are derived, and then a seamless gain spectrum can be realized.

(Relational Expression in this Example)

RΔ=−0.013163+(1.0952+(0.0235−32.738×λc)×Ra2)×Ra1

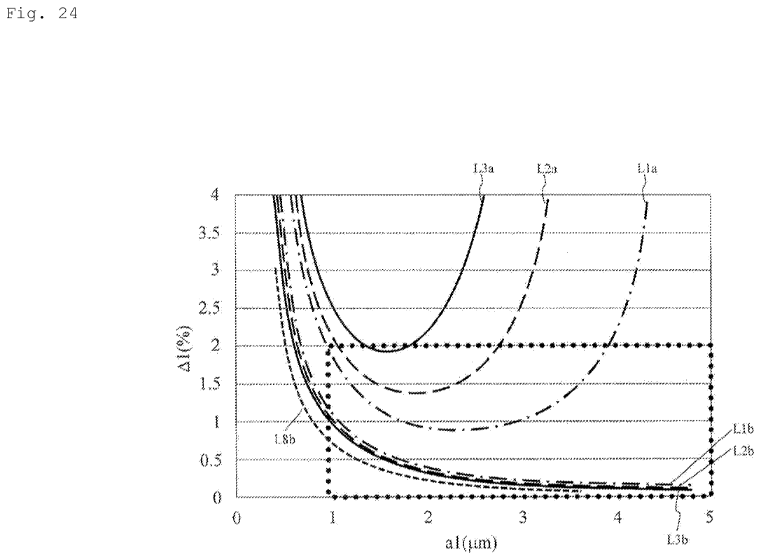

Further, when connecting the rare-earth-doped optical fiber 20 and a normal SMF, the connection loss varies greatly depending on the structural conditions of the optical fiber 25. FIG. 24 is a diagram plotting splice loss in relation to a1 and Δ1 (wavelength is 1530 nm).

A region between dashed-dotted lines L1a and L1b is a design range in which the connection loss is 1 dB or less.

A region between dashed lines L2a and L2b is a design range in which the connection loss is 2 dB or less.

A region between solid lines L3a and L3b is a design range in which the connection loss is 3 dB or less.

The area above the dotted line L8b (the upper limit line L8a is outside the graph in FIG. 24) is design range where the connection loss is less than 8 dB.

Using a graph such as that shown in FIG. 24, a1 and Δ1 are determined within the connection loss allowed for the optical fiber amplifier. However, if Δ1 is 2% or more, the degree of manufacturing difficulty increases, and therefore, it is desirable that more than a1>=1 μm corresponding to Δ1<=2%, and the difficulty in manufacturing becomes high.

### Example

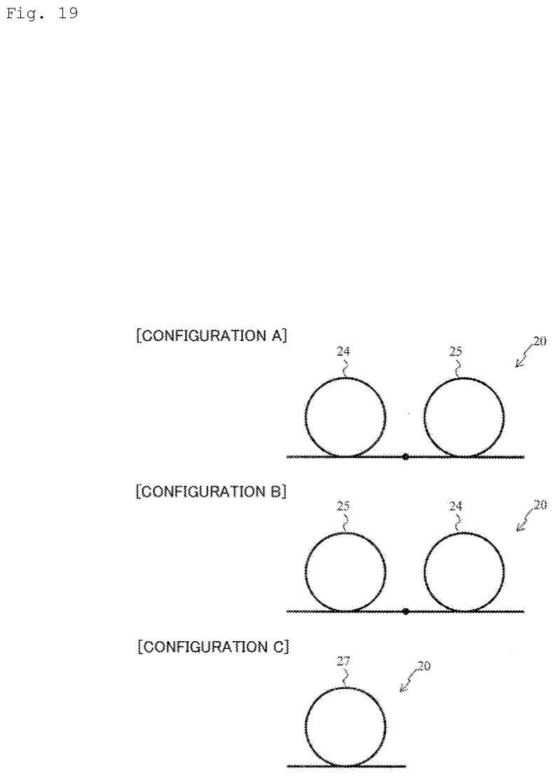

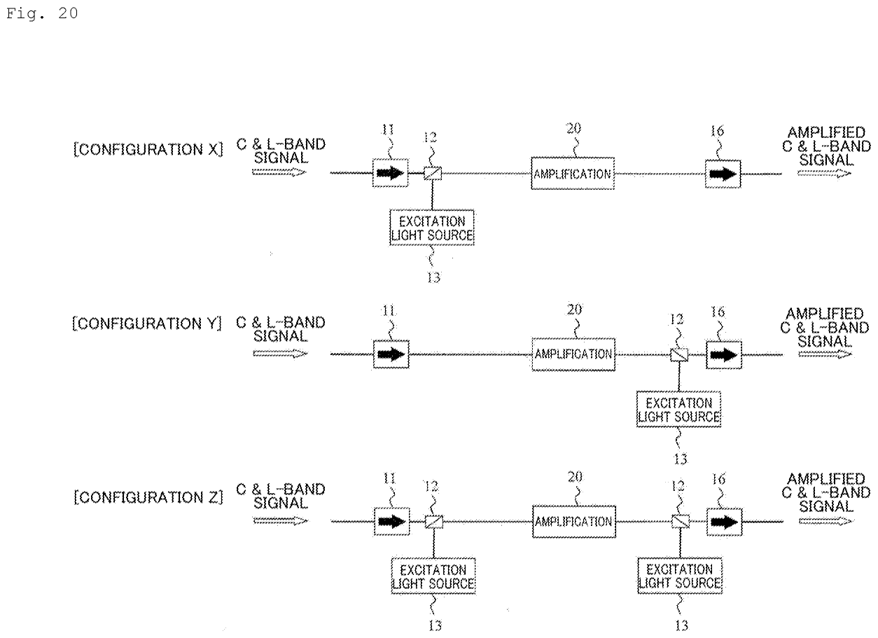

The optical fiber amplifier of this embodiment has the configure Z shown in FIG. 20, and the amplifying medium 20 has the configure A shown in FIG. 19.

The functions of the units are as follows.

The excitation light source for the optical fiber 24 of the front stage is configured to
excitation wavelength: 980 nm, and
excitation light power: 300 mW.

The optical fiber 24 is an EDF of core excitation,
Er doping concentration of 800 ppm,
fiber length: 6 m,
core diameter: 6.8 μm, and
relative refractive index difference: 0.8%.

The excitation light source for the optical fiber 25 in the rear stage has
excitation wavelength: 980 nm, and
excitation light power: 3 W.

The optical fiber 25 is a cladding excitation EDF,
an Er doping concentration of 800 ppm,
a fiber length of 130 m,
a core diameter of 6.8 μm (a1=3.4 μm),
a relative refractive index difference of 0.8% (Δ1),
a structural parameters of a2=9.5 μm, a3=18 μm, Δ2=0.53%.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results were a gain of 20 dB or more and a gain deviation within 2 dB or less at 1535 nm-1605 nm, and a noise figure of 5 dB or less.

As the rare-earth ions to be added, praseodymium, ytterbium, thulium, neodymium or the like can be used, and equivalent effects can be obtained.

### Embodiment 2

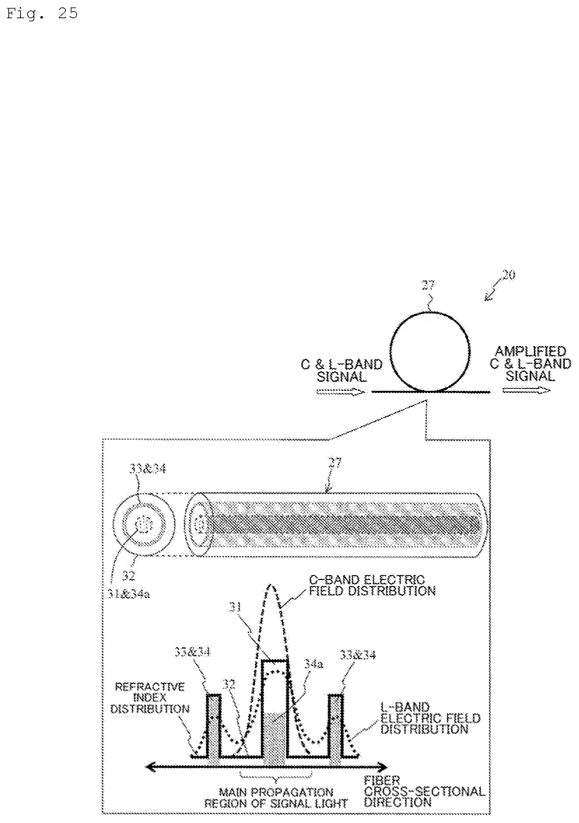

FIG. 25 is a view for explaining the rare-earth-doped optical fiber 20 included in the optical fiber amplifier of the present embodiment. The rare-earth-doped optical fiber 20 of this embodiment is an optical fiber 27 over the entire length. In the optical fiber 27, erbium ions are added to the central core 31 and the ring-shaped core region 33 in the cladding portion 32, and the refractive index distribution shape is a segment type profile. In the optical fiber 27, reference sign 31 denotes a central core, reference sign 32 denotes a cladding portion, reference sign 33 denotes a core region having a high refractive index (in this embodiment, it is ring-shaped), and reference signs 34 and 34a doped region with erbium ions.

The doped region 34a substantially coincides with the central core 31. Although the doped region 34 and the core region 33 are substantially coincident with each other, they are not necessarily coincident with each other. The doped region 34 a must be outside the C-band electric field distribution (the overlapping ratio of the C-band electric field distribution with the doped region 34 is several percent or less) and not adjacent to the central core 31.

Further, since the rare-earth-doped optical fiber 20 of this embodiment can amplify the C-band and the L-band at approximately the same amplification factor, the optical fiber structure is only one stage.

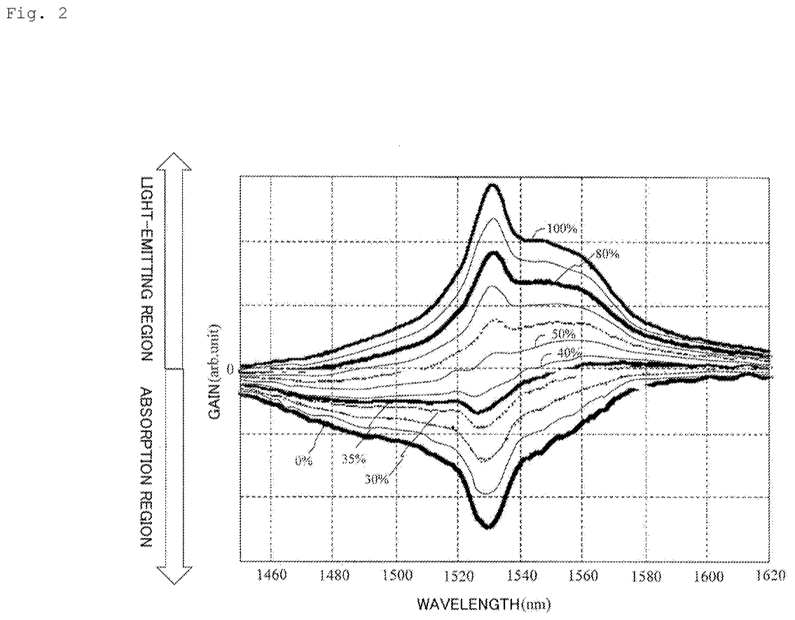

The optical fiber 27 amplifies C-band and L-band signal light with the central core 31 having high population inversion state. As shown in FIG. 2, in the state of high population inversion state, the gain in the L band is relatively low compared to that in the C band. Therefore, in this embodiment, the gain of the L band, which is insufficient for the C-band, is compensated for by the amplification of the L-band by the doped region 34. As a result, the rare-earth-doped optical fiber 20 enables seamless collective amplification from the C-band to the L-band as a whole.

Further, in order to obtain broadband gain flatness, the population inversion state (averaged in the longitudinal direction of the fiber) of the cladding portion 32 is lowered to achieve optical amplification centered on the L band, and at the same time, the L band per unit ion is low, and it is necessary to compensate for band amplification efficiency (see FIG. 2). As a method of compensating the amplification efficiency, there is a method of increasing the number of erbium ions involved in amplification (increasing the erbium-doped concentration, lengthening the length of the erbium-doped fiber, and the like).

That is, in the rare-earth-doped optical fiber of this embodiment, the doping concentration of rare-earth ions in at least one doped region is adjusted to be different from the doping concentration of rare-earth ions in the other doped regions.

For example, in the optical fiber 27, the erbium-doped concentration of the doped region 34a of the central core 31 is relatively low to increase the population inversion state, and the erbium-doped concentration of the doped region 34 of the core region 33 is relatively high to reduce population inversion state. In this way, by setting different population inversion states and different doping concentrations for each doped region, it is possible to achieve broadband and gain-flat optical amplification. However, if the erbium-doped concentration is too high (Er doping concentration: more than 2000 ppm), and concentration quenching occurs between erbium ions and amplification efficiency decreases concentration quenching occurs between erbium ions and amplification efficiency decreases, therefore, the erbium-doped concentration must be set so that the erbium ion concentrations in the doped regions 34a, 34 differ to the extent that the erbium-doped concentration is not excessive. There has been no report so far that there is a plurality of optical fiber amplifying media in which the main propagation region of the signal light is one and the population inversion state of the rare-earth ions is averaged in the longitudinal direction of the optical fiber.

### Example

The results of two configurations are shown as examples of the optical fiber amplifier of this embodiment.

### First Example

The optical fiber amplifier of this embodiment has the configuration X shown in FIG. 20, and the amplifying medium 20 has the configuration C shown in FIG. 19.

Its specifications are as follows.

The excitation light source has
excitation wavelength: 980 nm, and
excitation light power: 4 W.

The optical fiber 27 is a core excitation and cladding excitation EDF, and has
Er doping concentration in the doped region 34a: 50 ppm,
Er doping concentration in the doped region 34: 1000 ppm,
EDF length of 150 m, and
core diameter of 4.8 μm (a1=2.4 μm),
relative refractive index difference: 1.0% (Δ1), and
structural parameters: a2=8.5 μm, a3=16 μm, d2=0.53%.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results were a gain of 20 dB or more and a gain deviation of 2 dB or less at 1537 nm-1602 nm, and a noise figure of 7 dB or less.

### Second Example

The optical fiber amplifier of this example has configuration Z (forward excitation for core excitation and backward excitation for cladding excitation) in FIG. 20, and the amplification medium 20 has configuration C in FIG. 19.

Its specifications are as follows.

The excitation light source for core excitation has
excitation wavelength: 980 nm, and
excitation light power: 400 mW.

The excitation light source for cladding excitation has
excitation wavelength: 1480 nm, and
excitation light power: 3 W.

The specification of the optical fiber 27 is the same as that of First Example.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results were a gain of 20 dB or more and a gain deviation of 2 dB or less at 1537 nm-1602 nm, and a noise figure of 6 dB or less.

Since the forward excitation is used as the core excitation, the excitation light density of the core portion near the input end of the EDF is increased and a high population inversion state is formed, so that a low noise characteristic is obtained as compared with the optical fiber amplifier of First Example. Further, a low population inversion state of the doped region 34 and a high amplification factor are realized by the cladding excitation of backward excitation and the excitation wavelength of 1480 nm. In this configuration, the core portion realizes a high population inversion state and the cladding portion realizes a low population inversion state.

As the rare-earth ions to be added, praseodymium, ytterbium, thulium, neodymium or the like can be used, and equivalent effects can be obtained.

### Third Embodiment

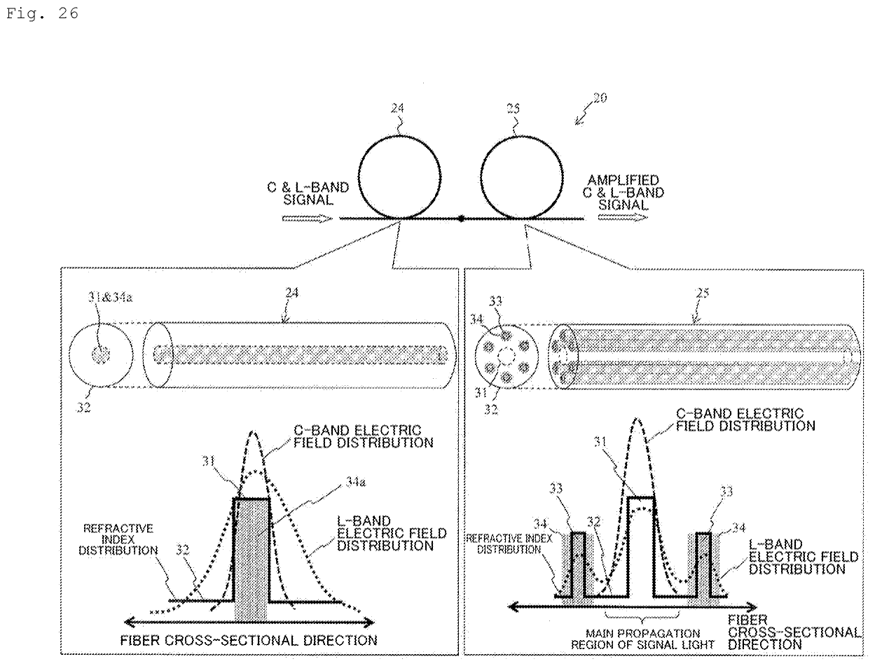

FIG. 26 is a diagram for explaining the rare-earth-doped optical fiber 20 included in the optical fiber amplifier of this embodiment.

The rare-earth-doped optical fiber 20 of this embodiment has a step-type optical fiber 24 in which the central core is doped with erbium ions on the front stage side, and an optical fiber 24 on the rear stage side that has a multi-core refractive index profile and a ring portion doped with erbium ions. 25 are connected in series. In each optical fiber, reference sign 31 denotes a central core, reference sign 32 denotes a cladding portion, reference sign 33 denotes a core region having a high refractive index (in this embodiment, a core portion other than the central core), and reference sign 34 denotes doped regions doped erbium ions.

The doped region 34 of the optical fiber 24 substantially coincides with the central core 31. Although the doped region 34 and the core region 33 of the optical fiber 25 are substantially coincident with each other, they are not necessarily coincident with each other. In FIG. 26, the diameter of the doped region 34 is larger than that of the core region 33.

In order to improve the amplification efficiency of the L-band, a core region 33 is provided in the vicinity of the erbium-doped region 34 of the cladding portion 32 in the present embodiment having a high refractive index. Thus, the electric field of the L-band is drawn into the high refractive region, and the overlapping of the doped region 34 and the electric field of the L-band is increased, and the amplification efficiency is improved. Further, since absorption of the C-band signal into erbium ions is also reduced, noise reduction and a wide band can be achieved. However, it is desirable that the core region 33 has a structure which is less than the cut-off wavelength of the basic mode in order to prevent a new intrinsic propagation mode from being generated in the portion.

### EXAMPLE

The optical fiber amplifier of this embodiment has configuration Z in FIG. 20, and the amplification medium 20 has configuration A in FIG. 19.

Its specifications are as follows.

The excitation light source for optical fiber 24 of the front stage has
excitation wavelength: 980 nm, and
excitation light power: 300 mW.

The optical fiber 24 is a core excitation EDF, and has
Er doping concentration of 1000 ppm,
Fiber length 6 M, 6 M, and 6 M
fiber length of 6 m, a core diameter of 4.5 μm, and
relative refractive index difference: 0.9%.

The excitation light source for optical fiber 25 of the rear stage has
excitation wavelength: 980 nm, and
excitation light power: 3 W.

The optical fiber 25 is a cladding excitation EDF, and has
a fiber length of 40 m,
a diameter of the central core 31: 4.5 μm,
a relative refractive index difference of the central core 31: 0.9%,
an Er doping concentration of the central core 31: none,
a diameter of core region 33 of 1 μm,
a distance between center of optical fiber 25 and center of core region 33: 16 μm,
a refractive index difference of core region 33: 0.6%, the number of core regions 33: 6,
the diameter of doped region 34: 6 μm,
distance between the center of the optical fiber 25 and the center of the doped region 34: 16 μm (aligned with the center of the side core),
Er doping concentration of the doped region 34: 1000 ppm, and the number of doped regions 34: 6.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results achieved a gain of 20 dB or more and a gain deviation within 2 dB or less at 1540 nm-1590 nm, and a noise figure of 7 dB or less.

As the rare-earth ions to be added, praseodymium, ytterbium, thulium, neodymium or the like can be used, and equivalent effects can be obtained.

### Fourth Embodiment

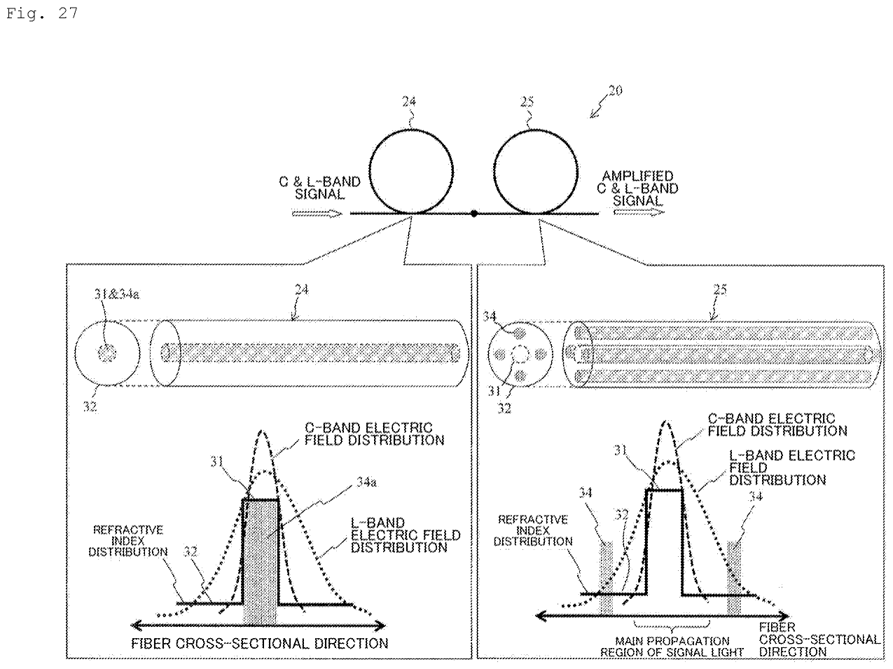

FIG. 27 is a view for explaining the rare-earth-doped optical fiber 20 included in the optical fiber amplifier of the present embodiment. In the rare earth-doped optical fiber 20 of this embodiment, a step-type optical fiber 24 with erbium ions added to the central core on the front stage side and a step-type optical fiber 25 with a refractive index distribution on the rear stage side, but with the optical fiber 25, which has no erbium ions added and has erbium ions added to the outer cladding portion of the central core, is connected in series. In each optical fiber, reference sign 31 denotes a central core, reference sign 32 denotes a cladding portion, and reference sign 34 denotes a ring-shaped doped region to which erbium ions are added (ring-shaped in this embodiment). The doped region 34a of the optical fiber 24 is almost coincident with the central core 31.

C-band and L-band optical amplification is performed in the optical fiber 24 in a high population inversion state (60% or more). However, as explained with reference to FIG. 2, since the population inversion state is high, the optical fiber 24 has a lower gain in the L band than in the C band. The C-band and L-band optical signals amplified by the optical fiber 24 are input to the optical fiber 25 in the rear stage. In the optical fiber 25, only the L-band electric field is applied to the erbium ion doped region 34, and a gain corresponding to the state of population inversion state of the erbium ions can be obtained. On the other hand, since the electric field of the C-band is hardly applied to the erbium ion-doped region 34, no gain is obtained, but the loss of the C-band signal in the low population inversion state, which has been a conventional problem, is almost eliminated. As a result, the rare-earth-doped optical fiber 20 can be amplified around the C-band at the front stage and amplified around the L-band at the rear stage, so that seamless batch amplification from the C-band to the L-band can be performed as a whole.

### Example

The optical fiber amplifier of this embodiment has configuration Z in FIG. 20, and the amplification medium 20 has configuration A in FIG. 19.

The reason is as follows.

The excitation light source for optical fiber 24 of the front stage has
excitation wavelength: 980 nm, and
excitation light power: 300 mW.

The optical fiber 24 is an EDF of core excitation, and has an Er doping concentration of 1000 ppm,
a fiber length of 8 m,
a core diameter of 4 μm, and
relative refractive index difference of 1%.

The excitation light source for optical fiber 25 of the rear stage has
an excitation wavelength of 980 nm, and
an excitation light power of 3 W.

The optical fiber 25 is a cladding excitation EDF, and has
a fiber length of 60 m,
a core diameter of 4 μm, and
a relative refractive index difference of 1%,
a cutoff wavelength of 960 nm,
a diameter of the doped region 34 of 5 μm, and
a distance between center of optical fiber 25 and center of doped region 34 of 15 μm,
the Er doping concentration of the doped region 34 is 1000 ppm, and
the number of doped regions 34 is 4.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results achieved a gain of 20 dB or more and a gain deviation within 3 dB or less at 1545 nm-1585 nm, and a noise figure of 7 dB or less.

Although it is possible to use the configuration B described in FIG. 19 as the amplification medium 20, there is a possibility that the noise characteristics may be degraded if the C-band signal is slightly absorbed by the erbium ions before obtaining a sufficient gain, therefore, configuration A is desirable.

As the rare-earth ions to be added, praseodymium, ytterbium, thulium, neodymium or the like can be used, and equivalent effects can be obtained.

### Fifth Embodiment

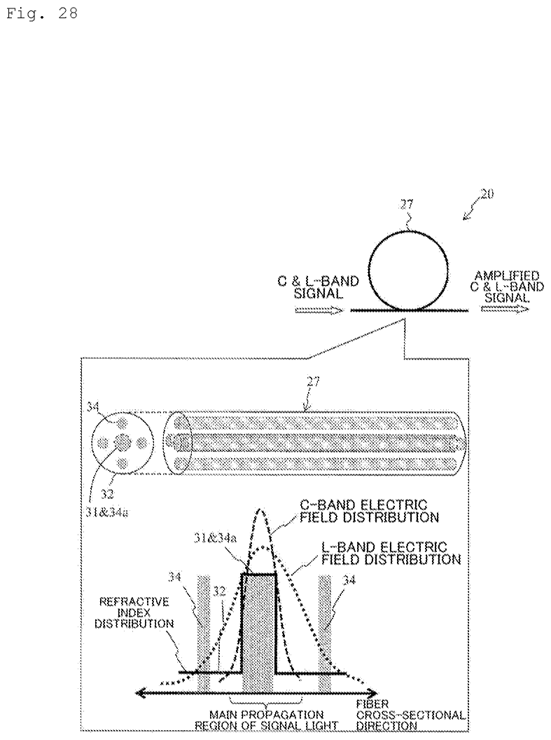

FIG. 28 is a diagram for explaining the rare-earth-doped optical fiber 20 provided in the optical fiber amplifier of this embodiment. The rare-earth-doped optical fiber 20 of this embodiment is an optical fiber 27 over the entire length. The optical fiber 27 is a step-type optical fiber in which erbium ions are added to both of the central core 31 and the cladding portion 32. In the optical fiber 27, reference sign 31 denotes a central core, reference sign 32 denotes a cladding portion, and reference signs 34 and 34a denote doped regions to which erbium ions are added.

The addition region 34a is roughly coincident with the central core 31. The erbium-doped region 34 of the cladding portion 32 must be located where the C-band electric field distribution is not nearly applied (the overlap ratio of the C-band electric field distribution to the cladding portion erbium-doped region is less than a few percent), and not adjacent to the central core 31.

Further, since the rare-earth-doped optical fiber 20 of this embodiment can amplify the C-band and the L-band at approximately the same amplification factor, the optical fiber structure is only one stage.

The optical fiber 27 amplifies C-band and L-band signal light with the central core 31 having high population inversion state. As shown in FIG. 2, in the state of high population inversion state, the gain in the L band is relatively low compared to that in the C band. Therefore, in this embodiment, the gain of the L band, which is insufficient for the C-band, is compensated for by the amplification of the L-band by the doped region 34. As a result, the rare-earth-doped optical fiber 20 enables seamless collective amplification from the C-band to the L-band as a whole.

### Example

The results of two configurations are shown as examples of the optical fiber amplifier of this embodiment.

### First Example

The optical fiber amplifier of this embodiment has the configuration X shown in FIG. 20, and the amplifying medium 20 has the configuration C shown in FIG. 19.

The specifications are as follows.

The excitation light source has
an excitation wavelength of 980 nm, and
an excitation light power of 4 W.

The optical fiber 27 is a core excitation and cladding
excitation EDF, and has
an Er doping concentration of the central core 31: 500 ppm,
a diameter of the central core 31: 4 μm,
a relative refractive index difference of the central core 31: 0.9%,
a doping concentration of a doped region 34: 1000 ppm,
a diameter of the doped region 34: 6 μm,
a distance between the center of the optical fiber 27 and the center of the doped region 34 is 17 μm,
the number of doped regions 34 is 4, and
the fiber length of 30 m.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results were a gain of 20 dB or more and a gain deviation of 2 dB or less at 1543 nm-1582 nm, and a noise figure of 8 dB or less.

### Second Example

The optical fiber amplifier of this example has configuration Z (forward pumping for core excitation and backward excitation for cladding excitation) in FIG. 20, and the amplification medium 20 has configuration C in FIG. 19.

The specifications are as follows.

The excitation light source for core excitation has
an excitation wavelength of 980 nm, and
an excitation light power of 400 mW.

The excitation light source for cladding excitation has
an excitation wavelength of 1480 nm, and
an excitation light power of 3 W.

The specification of the optical fiber 27 is the same as that of First Example.

The amplification characteristics are evaluated wavelength by wavelength scanning of a small signal under the condition of the input signal optical power of −13 dBm/ch, and signal wavelength of 1550 nm, 1560 nm, 1570 nm, and 1580 nm, and the results were a gain of 22 dB or more and a gain deviation of 2 dB or less at 1542 nm-1583 nm, and a noise figure of 7 dB or less.

Since the forward excitation is used as the core excitation, the excitation light density of the core portion near the input end of the EDF is increased and a high population inversion state is formed, so that a low noise characteristic is obtained as compared with the optical fiber amplifier of First Example. Further, a low population inversion state of the doped region 34 and a high amplification factor are realized by the cladding excitation of backward excitation and the excitation wavelength of 1480 nm. In this configuration, the core portion realizes a high population inversion state and the cladding portion realizes a low population inversion state.

As the rare-earth ions to be added, praseodymium, ytterbium, thulium, neodymium or the like can be used, and equivalent effects can be obtained.

### APPENDIX

Hereinafter, the optical fiber amplifier of the present embodiment will be described.

### [Points of Invention]

In the cross-section of the optical fiber for amplification, there are one main propagation region of signal light, at least two or more kinds of cross-sectional regions to which rare-earth ions are added in the propagation direction of the optical fiber for amplification, and the doped region of the rare-earth ions is controlled according to an amplification wavelength band related to the propagation region of the signal light partially different. As means for partially forming different propagation regions of signal light based on the above basic concept, there are a means for setting a region having a refractive index higher than that of a clad outside the central core and realizing it by light wave coupling, and a means for utilizing a difference in spread of electric field distribution accompanying wavelength dependence of the signal light.

### [Description of Configuration]

### Configuration (1):

A rare-earth-doped optical fiber and an optical fiber amplifier, characterized in that a main propagation region of signal light is one in a cross-section of the optical fiber for amplification, at least two kinds of cross-sectional regions to which rare-earth ions are added exist in a propagation direction of the optical fiber for amplification, and a doped region of the rare-earth ions is controlled in accordance with an amplification wavelength band.

### Configuration (2):

The rare earth-doped optical fiber and the optical fiber amplifier, characterized in that the amplifying optical fiber described in the configuration (1) has the different doping concentration of the plurality of rare-earth ions regions.

### Configuration (3):

The rare-earth-doped optical fiber and the optical fiber amplifier, characterized in that a plurality of different population inversion states exist locally in doped regions of the plurality of rare-earth ions of the optical fiber for amplification, and the population inversion states used are different depending on an amplification wavelength band.

### Configuration (4):

A rare-earth-doped optical fiber and an optical fiber amplifier of the configuration (3), characterized in that the population inversion state of rare-earth ions in an doped region corresponding to a propagation region of a part of amplification wavelength bands on the front side is higher than the population inversion state of rare-earth ions in an doped region corresponding to a propagation region of the other amplification wavelength band on the rear side in the optical fiber longitudinal direction of the optical fiber for amplification.

### Configuration (5):

A rare-earth-doped optical fiber and an optical fiber amplifier characterized in that a plurality of main signal light propagation regions in configurations (1) to (4) exist in a non-correlated manner within the cross-section of the amplification optical fiber.

### Configuration (6):

The rare-earth-doped optical fiber and the optical fiber amplifier of configurations (1) to (5), characterized in that the central core is disposed in the cladding region with a uniform refractive index and has a higher refractive index than the cladding region, and the side cores are disposed in the cladding region that is concentric to the core center and has a higher refractive index than the cladding region, and the propagation region of each signal wavelength is controlled by lightwave coupling between the central core and side cores.

### Configuration (7):

A rare-earth-doped optical fiber and an optical fiber amplifier described in the configuration (6), characterized in that at least one or more of the side cores are discretely arranged in concentric circular positions with the center of gravity at the center of the central core.

### Configuration (8):

The rare-earth-doped optical fiber according to configuration (6)-(7), characterized in that the central wavelength of the coexistence wavelength range of the super mode and the fundamental mode is 1530 nm-1650 nm, and the coexistence wavelength range is 30 nm-180 nm and optical fiber amplifiers.

### Configuration (9):

A rare-earth-doped optical fiber and an optical fiber amplifier of the configurations (6) to (8), characterized in that the cross-sectional structure of the rare-earth-doped fiber has a segment-type refractive index profile, the central core and side cores form different propagation regions, and the relative refractive index difference between the central core and the clad is Δ1, the relative refractive index difference with respect to the cladding portion of the ring-shaped core is Δ2, the radius of the center core is a1, the radius of the inner edge of the side core is a2, the radius of the outer edge of the side core is a3, RΔ=Δ2/Δ1, Ra1=a2/a3, when defined as Ra2=a2/a3, Δ1, Δ2, a1, a2, and a3 are determined based on the relationship RΔ∝ (b+c×Ra2)×Ra1 [b, c are coefficients].

### Configuration (10):

A rare-earth-doped optical fiber and an optical fiber amplifier described in configurations (1) to (5) are arranged in a clad region with a uniform refractive index and having a central core with a higher refractive index than the clad region, each signal wavelength characterized in that the propagation region of is controlled by a difference in spread of an electric field distribution caused by wavelength dependence of signal light.

### Configuration (11):

The rare-earth-doped optical fiber according to configuration (10), characterized in that the region where the rare-earth is doped concentrically from the central core center is set annularly with respect to the central core center.

### Advantageous Effects of Invention

Conventionally, a wide-band rare-earth-doped optical fiber amplifier for collectively amplifying the C-band and the L-band has been realized by branching the C-band and the L-band and connecting different amplifiers in parallel. The amplifier of the present invention has a configuration significantly simpler than the conventional one by one or series connection, does not require a gain equalizer, and can perform broadband amplification. Further, an unusable region located at the boundary between the C-band and the L-band which has been a conventional problem is made usable, and seamless wide band amplification is realized. Thus, the setting limit of the signal wavelength is greatly relaxed.

### REFERENCE SIGNS LIST

11, 16: Isolator
12: Multiplexer/demultiplexer
13: Excitation light source
14, 15: Optical amplifier
20: Amplification medium (rare-earth-doped optical fiber)
24: Optical fiber (for C-band amplification)
25: Optical fiber (for L-band amplification)
27: Optical fiber (for C-band and L-band amplification)
31: Central core
32: Cladding part
33: Core region (region with higher refractive index higher than cladding portion)
34, 34a: Doped region

1. An optical fiber amplifier that amplifies a plurality of wavelength bands,
the optical fiber amplifier comprises a rare-earth-doped optical fiber, wherein
a cross-section of the rare-earth-doped optical fiber comprises a main propagation region for signal light, and a doped region doped with rare-earth ions, and the doped region exists other than the propagation region.

2. The optical fiber amplifier according to claim 1, wherein the rare-earth-doped optical fiber is divided into a plurality of sections, and an arrangement of the doped region is different for each of the sections.

3. The optical fiber amplifier according to claim 1, wherein the rare-earth-doped optical fiber has the same arrangement of the doped regions over the entire section, and the propagation region is also doped with rare-earth ions.

4. The optical fiber amplifier according to claim, wherein the rare-earth-doped optical fiber has a doping concentration of the rare-earth ions in at least one of the doped regions different from a doping concentration of the rare-earth ions in other of the doped regions.

5. The optical fiber amplifier according to claim 1, wherein the rare-earth-doped optical fiber has a population inversion state formed for each of the doped regions, and the population inversion state used for each of the wavelength bands is different.

6. The optical fiber amplifier according to claim 2, wherein the rare-earth-doped optical fiber, within a cross-section of an optical fiber, has a central core in the propagation region and a core region concentrically arranged with respect to the central core, and in at least one of the sections, the core region is the doped region.

7. The optical fiber amplifier according to claim 2, wherein the rare-earth-doped optical fiber has a central core in the propagation region within a cross-section of an optical fiber, and in at least one of the sections, the doped region is concentrically arranged with respect to the central core.

8. The optical fiber amplifier according to claim 2, wherein the rare-earth-doped optical fiber, within a cross-section of an optical fiber, has a central core in the propagation region and a core region concentrically arranged with respect to the central core, and the doped region has the central core and the core region.

9. The optical fiber amplifier according to claim 2, wherein the rare-earth-doped optical fiber has a central core that is the propagation region, within a cross-section of the optical fiber, and the doped region is arranged at a position of the central core and arranged concentrically with respect to the central core.

10. The optical fiber amplifier according to claim 8, wherein the doped region located at the position of the central core and the doped region arranged concentrically with respect to the central core have different doping concentrations of the rare-earth ions.

11. The optical fiber amplifier according to claim 1, wherein the rare-earth-doped optical fiber has a plurality of sets of the propagation region and the doped region within a cross-section of the optical fiber, and the sets are non-correlated with each other in amplification of the wavelength band.

12. The optical fiber amplifier according to claim 3, wherein the rare-earth-doped optical fiber, within a cross-section of an optical fiber, has a central core in the propagation region and a core region concentrically arranged with respect to the central core, and the doped region has the central core and the core region.

13. The optical fiber amplifier according to claim 3, wherein the rare-earth-doped optical fiber has a central core that is the propagation region, within a cross-section of the optical fiber, and the doped region is arranged at a position of the central core and arranged concentrically with respect to the central core.

14. The optical fiber amplifier according to claim 9, wherein the doped region located at the position of the central core and the doped region arranged concentrically with respect to the central core have different doping concentrations of the rare-earth ions.

15. The optical fiber amplifier according to claim 12, wherein the doped region located at the position of the central core and the doped region arranged concentrically with respect to the central core have different doping concentrations of the rare-earth ions.

16. The optical fiber amplifier according to claim 13, wherein the doped region located at the position of the central core and the doped region arranged concentrically with respect to the central core have different doping concentrations of the rare-earth ions.
